(19) United States
(12) Patent Application Publication
(10) Pub. No.: US 2024/0347747 A1
(43) Pub. Date: Oct. 17, 2024

(54) FUEL CELL SYSTEM

(71) Applicant: TOYOTA JIDOSHA KABUSHIKI KAISHA, Toyota-shi (JP)

(72) Inventors: Makito OKUMURA, Nagoya-shi (JP); Ryouichi NAMBA, Okazaki-shi (JP)

(73) Assignee: TOYOTA JIDOSHA KABUSHIKI KAISHA, Toyota-shi (JP)

(21) Appl. No.: 18/585,561

(22) Filed: Feb. 23, 2024

(30) Foreign Application Priority Data
Apr. 11, 2023 (JP) 2023-064386

(51) Int. Cl. H01M 8/0438; H01M 8/04119

(52) U.S. Cl. CPC H01M 8/04402; H01M 8/04164; H01M 2250/20

(57) ABSTRACT

A control device of a fuel cell system determines opening-closing abnormality of a first valve and a second valve based on a comparison between a first pressure decrease rate and a second pressure decrease rate, the first pressure decrease rate being a decrease rate of a pressure detection value of a pressure sensor when a first control is executed, the first control being a control in which the first valve is opened in a state where the second valve is closed, the second pressure decrease rate being a decrease rate of the pressure detection value of the pressure sensor when a second control is executed, the second control being a control in which the second valve is opened in a state where the first valve is closed.

### CROSS-REFERENCE TO RELATED APPLICATION

This application claims priority to Japanese Patent Application No. 2023-064386 filed on Apr. 11, 2023, incorporated herein by reference in its entirety.

### BACKGROUND

### 1. Technical Field

The present disclosure relates to a fuel cell system.

### 2. Description of Related Art

Conventionally, a fuel cell system has been known. A fuel cell system described in Japanese Unexamined Patent Application Publication No. 2020-017435 (JP 2020-017435 A) includes a fuel cell, an anode gas supply system, an anode gas circulation system, a cathode gas supply-emission system, a gas-liquid emission path, a gas-liquid emission valve for opening and closing the gas-liquid emission path, a flow rate acquisition unit, and a control unit.

In the fuel cell system described in JP 2020-017435 A, in a state where an opening instruction has been given to the gas-liquid emission valve, the control unit executes a normality-abnormality determination about the opening of the gas-liquid emission valve as described below. When the gas emission flow rate of anode gas is equal to or higher than a previously set normality reference value, the control unit determines that the gas-liquid emission valve has been normally opened, and when the gas emission flow rate is lower than the normality reference value, the control unit determines that the gas-liquid emission valve has not been normally opened.

Further, a fuel cell system described in Japanese Unexamined Patent Application Publication No. 2022-132887 (JP 2022-132887 A) includes a fuel cell, an oxidant gas supply pipe through which oxidant gas to the fuel cell flows, and an oxidant off-gas emission pipe through which oxidant off-gas from the fuel cell flows. Further, this conventional fuel cell system includes a pressure regulation valve that is provided in the oxidant off-gas emission pipe and that regulates the pressure of the oxidant gas in the fuel cell, a gas-liquid separator that is provided in the oxidant off-gas emission pipe and that separates liquid water from the oxidant off-gas, and a gas-liquid emission valve for both of the gas emission and liquid emission from a liquid storage portion of the gas-liquid separator.

Furthermore, the fuel cell system described in JP 2022-132887 A includes a pressure sensor that measures the pressure of the oxidant gas in the fuel cell, and an ECU. The ECU controls the pressure regulation valve at a previously set opening degree such that the pressure of the oxidant gas in the fuel cell becomes a target pressure. Thereafter, the ECU executes a pressure control to regulate the opening degree of the pressure regulation valve such that the pressure based on the measurement value measured by the pressure sensor becomes the target pressure, and determines that the gas-liquid emission valve has an opening-closing abnormality when the regulation width of the opening degree of the pressure regulation valve in the pressure control is larger than a predetermined value.

### SUMMARY

In the fuel cell system described in JP 2022-132887 A, when the gas-liquid emission valve breaks down during operation and the opening state is continued, anode off-gas leaks. However, it is difficult to set the normal range of the pressure decrease rate of low-pressure anode off-gas during the electricity generation of the fuel cell. Further, the fuel cell system described in JP 2020-017435 A can determine the opening abnormality of the gas-liquid emission valve. However, in the case where both the gas-liquid emission valve and a gas emission valve are included, there is fear that it is not possible to determine which of the gas-liquid emission valve or the gas emission valve has the abnormality.

The present disclosure provides a fuel cell system that can determine the opening-closing abnormality of the gas-liquid emission valve and the gas emission valve.

An aspect of the present disclosure is a fuel cell system including: a pressure sensor provided on an anode gas circulation path through which anode off-gas emitted from a fuel cell stack is circulated to the fuel cell stack; a first valve configured to open and close a gas emission path that branches from the anode gas circulation path; a second valve coupled to a gas-liquid separator provided on the anode gas circulation path, gas and liquid being emitted from the gas-liquid separator to a gas-liquid emission path at a time of opening of the second valve; and a control device configured to determine opening-closing abnormality of the first valve and the second valve, in which the control device determines the opening-closing abnormality of the first valve and the second valve based on a comparison between a first pressure decrease rate and a second pressure decrease rate, the first pressure decrease rate being a decrease rate of a pressure detection value of the pressure sensor when a first control is executed, the first control being a control in which the first valve is opened in a state where the second valve is closed, the second pressure decrease rate being a decrease rate of the pressure detection value of the pressure sensor when a second control is executed, the second control being a control in which the second valve is opened in a state where the first valve is closed.

With the above aspect of the present disclosure, it is possible to provide a fuel cell system that can determine the opening-closing abnormality of the first valve as the gas emission valve and the second valve as the gas-liquid emission valve.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a process flow diagram showing an embodiment of a fuel cell system according to the present disclosure;

FIG. 2 is a flowchart showing a process in a control device of the fuel cell system in FIG. 1;

FIG. 3 is time chart showing pressure detection values and opening-closing states of valves in processes in FIG. 2;

FIG. 4 is a flowchart showing another process in the control device of the fuel cell system in FIG. 1; and

FIG. 5 is a time chart showing pressure detection values and opening-closing states of valves in processes in FIG. 4.

### DETAILED DESCRIPTION OF EMBODIMENTS

An embodiment of a fuel cell system according to the present disclosure will be described below with reference to the drawings.

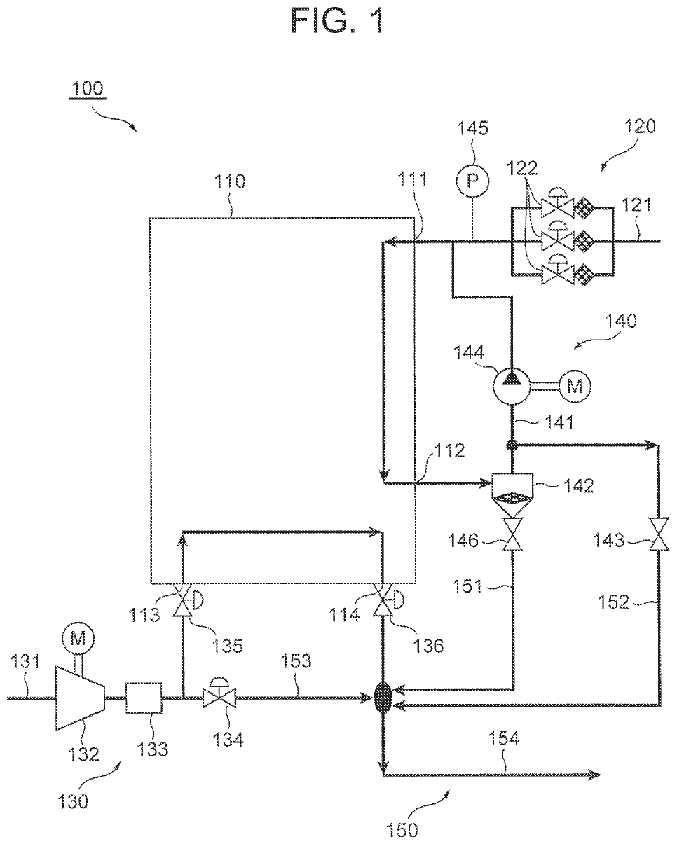

FIG. 1 is a process flow diagram showing the embodiment of the fuel cell system according to the present disclosure. For example, a fuel cell system 100 in the embodiment is equipped in a vehicle such as a fuel cell electric vehicle, and supplies electric power to in-vehicle devices including an electric motor for traveling. For example, the fuel cell system 100 in the embodiment includes a fuel cell stack 110, an anode gas supply system 120, a cathode gas supply system 130, an anode gas circulation system 140, and a gas-liquid emission system 150. Further, for example, the fuel cell system 100 includes an unillustrated coolant circulation system and an unillustrated control device.

For example, the fuel cell stack 110 has a configuration in which a plurality of unit cells as solid oxide fuel cells is stacked, and includes an anode gas inlet 111, an anode off-gas outlet 112, a cathode gas inlet 113, and a cathode off-gas outlet 114. Further, for example, the fuel cell stack 110 includes an unillustrated coolant inlet and an unillustrated coolant outlet.

For example, the anode gas supply system 120 includes an anode gas supply path 121 connected to an unillustrated high-pressure tank through a pressure reduction valve, and injectors 122, and supplies hydrogen gas as anode gas to the fuel cell stack 110. For example, the control device of the fuel cell system 100 can control the pressure of low-pressure anode gas that flows downstream of the injectors 122, by controlling the injectors 122.

For example, the cathode gas supply system 130 includes a cathode gas supply path 131 connected to an unillustrated air cleaner, a compressor 132, an intercooler 133, a flow dividing valve 134, a sealing valve 135, and a pressure regulation valve 136. The cathode gas supply system 130 compresses air as cathode gas that is supplied through the cathode gas supply path 131, with the compressor 132, cools the air with the intercooler 133, and supplies the air to the cathode gas inlet 113 of the fuel cell stack 110 through the sealing valve 135.

For example, the anode gas circulation system 140 includes an anode gas circulation path 141, a gas-liquid separator 142, a first valve 143 as a gas emission valve, a hydrogen pump 144, a pressure sensor 145, and a second valve 146 as a gas-liquid emission valve. For example, the anode gas circulation path 141 is a flow path that connects the anode off-gas outlet 112 and the anode gas inlet 111 of the fuel cell stack 110, and circulates anode off-gas emitted from the fuel cell stack 110, to the fuel cell stack 110.

For example, the gas-liquid separator 142 is provided on the anode gas circulation path 141, and separates liquid such as water that is included in the anode off-gas that flows through the anode gas circulation path 141, from the anode off-gas. For example, the second valve 146 as the gas-liquid emission valve is coupled to the gas-liquid separator 142, and at the time of the opening of the second valve 146, the gas and liquid are emitted from the gas-liquid separator 142 to the gas-liquid emission path 151 of the gas-liquid emission system 150. For example, the hydrogen pump 144 is provided on the anode gas circulation path 141, and feeds the anode off-gas emitted from the anode off-gas outlet 112 of the fuel cell stack 110, to the anode gas inlet 111.

For example, the pressure sensor 145 is provided on the anode gas supply path 121 on the downstream side of the injectors 122 or on the anode gas circulation path 141, and detects the pressure of the low-pressure anode gas including the anode gas that is supplied to the anode gas inlet 111 of the fuel cell stack 110. The first valve 143 as the gas emission valve that emits the anode gas including the anode off-gas from the anode gas circulation path 141 opens and closes a gas emission path 152 that branches from the anode gas circulation path 141 and that is coupled to a gas emission path 154 of the gas-liquid emission system 150. For example, the first valve 143 and the second valve 146 are the same in inner diameter, or are almost the same in pressure loss of the anode gas.

For example, the gas-liquid emission system 150 includes a gas-liquid emission path 151, a gas emission path 152, a flow dividing path 153, and an emission path 154. For example, the gas-liquid emission path 151 connects the outlet of the second valve 146 connected to the gas-liquid separator 142 and the emission path 154. For example, the gas emission path 152 branches from the anode gas circulation path 141, and is coupled to the emission path 154. For example, the flow dividing path 153 couples the outlet of the flow dividing valve 134 and the emission path 154. For example, the emission path 154 connects the outlet of the pressure regulation valve 136 and an unillustrated muffler.

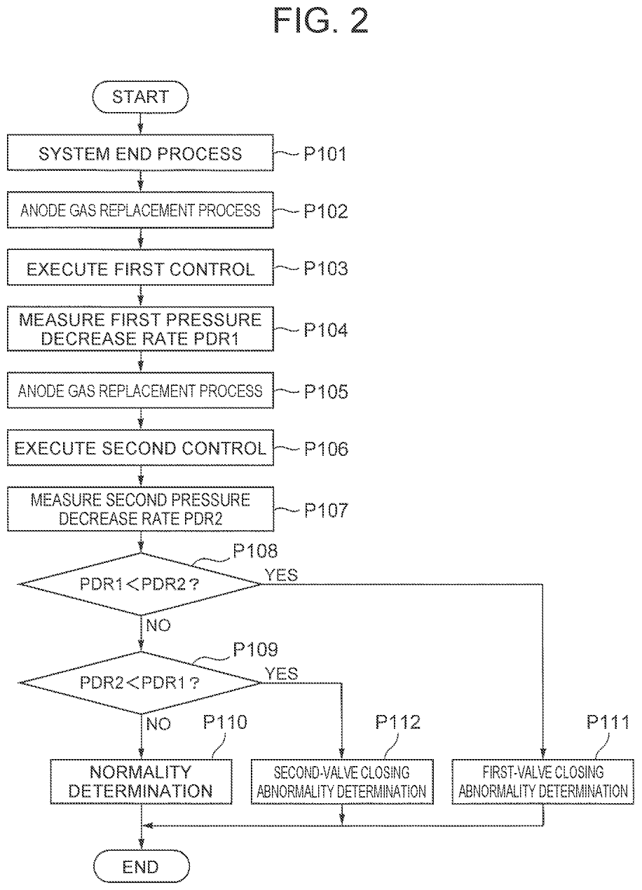

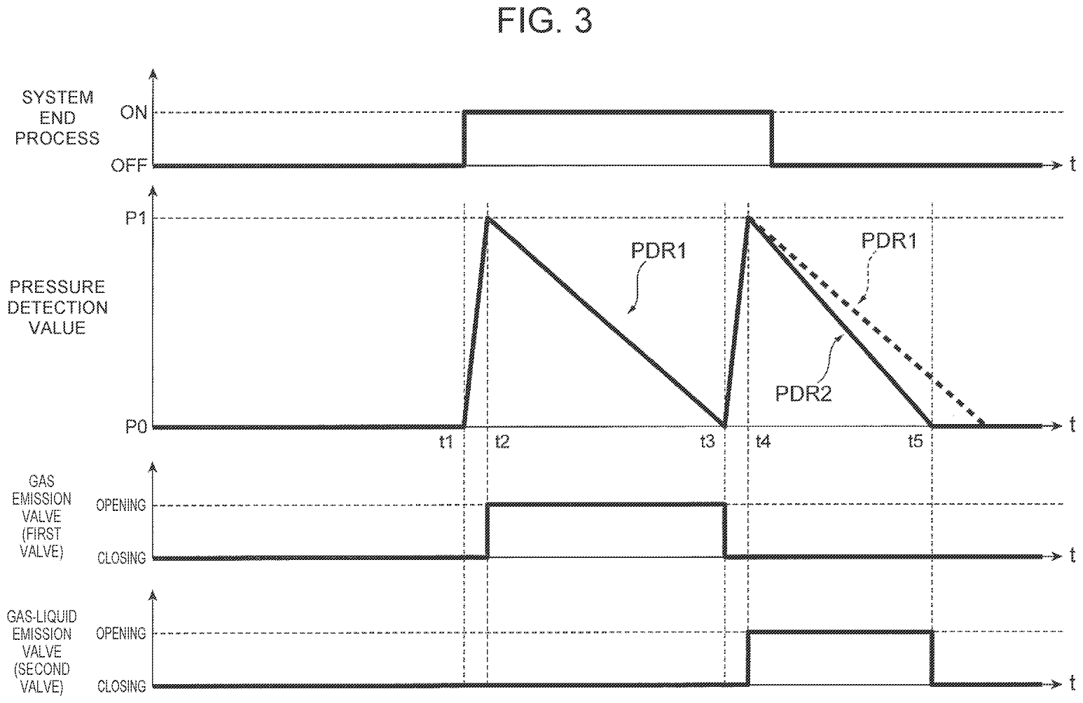

FIG. 2 is a flowchart showing a process in the control device of the fuel cell system 100 in FIG. 1. FIG. 3 is a time chart showing pressure detection values of the pressure sensor 145 and opening-closing states of the first valve 143 and the second valve 146 in processes in FIG. 2. For example, the control device of the fuel cell system 100 executes the processes shown in FIG. 2, and thereby determines the opening-closing abnormality of the first valve 143 as the gas emission valve and the second valve 146 as the gas-liquid emission valve, which are shown in FIG. 1. The processes shown in FIG. 2 will be described below in detail.

For example, when the vehicle equipped with the fuel cell system 100 stops at ordinary temperatures or after warm-up and a start-up switch is turned off, the control device of the fuel cell system 100 starts the processing flow shown in FIG. 2, and executes a system end process P101. Thereby, for example, as shown in FIG. 3, a system end process flag is switched from OFF to ON, and the end process P101 for the fuel cell system 100 is started.

Next, for example, the control device of the fuel cell system 100 executes an anode gas replacement process P102. In this process P102, for example, the control device of the fuel cell system 100 increases the pressure of the anode gas that is supplied to the fuel cell stack 110, by controlling the injectors 122. As a result, as shown in FIG. 3, for example, the pressure detection value of the pressure sensor 145 increases to a predetermined pressure P1 in a period from time t1 to time t2.

Next, for example, the control device of the fuel cell system 100 executes a first control (process P103). For example, the first control is a control in which the first valve 143 as the gas emission valve is opened in a state where the second valve 146 as the gas-liquid emission valve is closed. Concurrently with the start of the first control, the control device of the fuel cell system 100 starts a process P104 of measuring a first pressure decrease rate PDR1. In the process P104, for example, the control device of the fuel cell system 100 stores time-series in a memory data about the pressure detection value until the pressure detection value of the pressure sensor 145 decreases to a predetermined pressure P0.

By the process P103, the anode gas is emitted from the anode gas circulation path 141 through the first valve 143 as the gas emission valve, and as shown in FIG. 3, the pressure detection value of the pressure sensor 145 decreases from the pressure P1 to the predetermined pressure P0, in a period from time t2 to time t3. Further, by the process P104, the control device of the fuel cell system 100 can measure the first pressure decrease rate PDR1 that is the decrease rate of the pressure detection value when the first control is executed.

Next, for example, the control device of the fuel cell system 100 executes a second anode gas replacement process P105. In the process P105, the control device of the fuel cell system 100 closes both of the first valve 143 and the second valve 146, and increases the pressure of the anode gas in the anode gas circulation path 141, similarly to the above-described first anode gas replacement process P102. Thereby, for example, as shown in FIG. 3, the pressure detection value of the pressure sensor 145 increases to the predetermined pressure P1 in a period from time t3 to time t4.

Next, for example, the control device of the fuel cell system 100 executes a second control (process P106). For example, the second control is a control in which the second valve 146 as the gas-liquid emission valve is opened in a state where the first valve 143 as the gas emission valve is closed. Concurrently with the start of the second control, the control device of the fuel cell system 100 starts a process P107 of measuring a second pressure decrease rate PDR2, similarly to the above-described process P104 of measuring the first pressure decrease rate PDR1.

By the process P106, the anode gas is emitted from the anode gas circulation path 141 through the second valve 146 as the gas-liquid emission valve, and as shown in FIG. 3, the pressure detection value of the pressure sensor 145 decreases from the pressure P1 to the predetermined pressure P0, in a period from time t4 to time t5. Further, by the process P107, the control device of the fuel cell system 100 can measure the second pressure decrease rate PDR2 that is the decrease rate of the pressure detection value when the second control is executed.

Next, for example, the control device of the fuel cell system 100 executes at least one of a first determination process P108 and a second determination process P109. In the example shown in FIG. 3, the first pressure decrease rate PDR1 of the pressure detection value of the pressure sensor 145, which is the pressure decrease rate measured in the period from time t2 to time t3, is lower than the second pressure decrease rate PDR2 of the pressure detection value of the pressure sensor 145, which is the pressure decrease rate measured in the period from time t4 to time t5.

In this case, in the first determination process P108, for example, the control device of the fuel cell system 100 determines that the first pressure decrease rate PDR1 is lower than the second pressure decrease rate PDR2 (YES). In this case, the control device of the fuel cell system 100 executes a process P111 of determining that the first valve 143 as the gas emission valve has a first-valve closing abnormality that hinders the opening operation of the first valve 143, and ends the processing flow shown in FIG. 2.

On the other hand, for example, when the control device of the fuel cell system 100 determines that the first pressure decrease rate PDR1 is not lower than the second pressure decrease rate PDR2 in the above-described first determination process P108 (NO), the control device of the fuel cell system 100 executes the second determination process P109. For example, when the control device of the fuel cell system 100 determines that the second pressure decrease rate PDR2 is not lower than the first pressure decrease rate PDR1 in the second determination process P109 (NO), the control device of the fuel cell system 100 makes a normality determination (process P110) for the first valve 143 and the second valve 146, and ends the processing flow shown in FIG. 2.

Further, for example, when the control device of the fuel cell system 100 determines that the second pressure decrease rate PDR2 is lower than the first pressure decrease rate PDR1 in the above-described second determination process P109 (YES), the control device of the fuel cell system 100 executes a process P112 of determining that the second valve 146 as the gas-liquid emission valve has a second-valve closing abnormality that hinders the opening operation of the second valve 146, and ends the processing flow shown in FIG. 2.

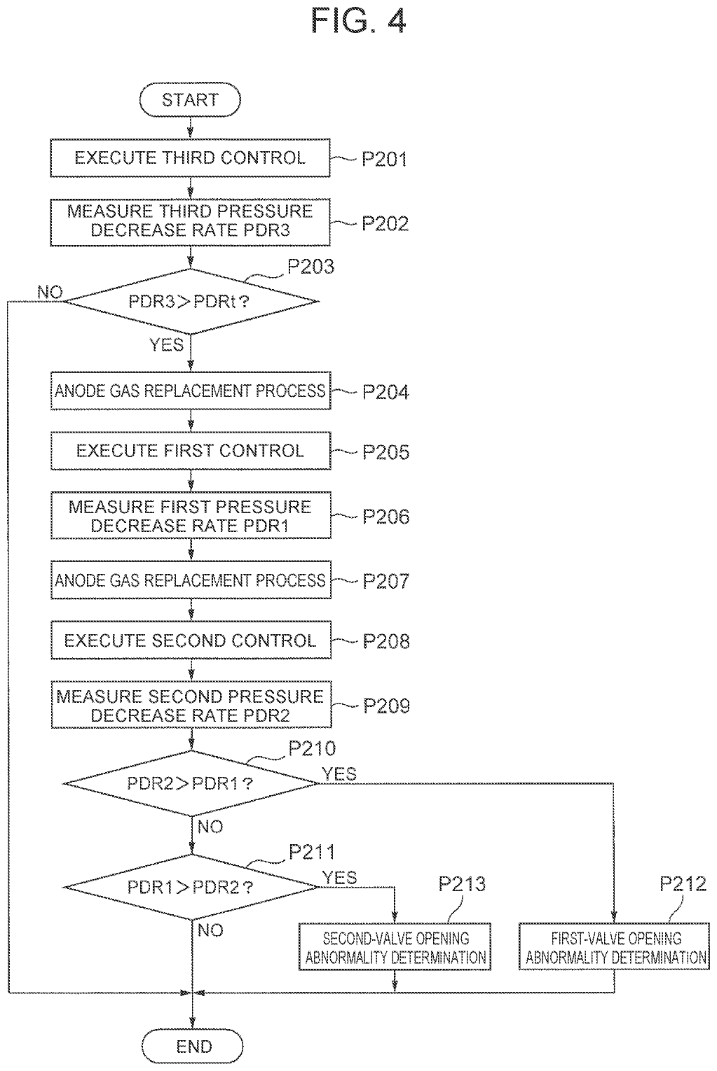

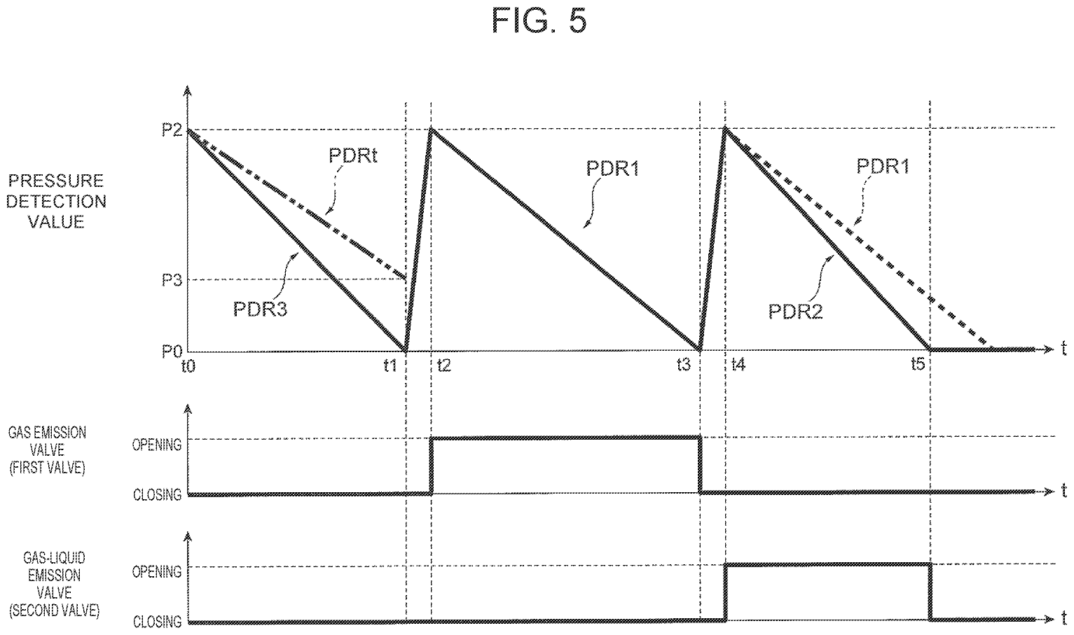

FIG. 4 is a flowchart showing another process in the control device of the fuel cell system 100 shown in FIG. 1. FIG. 5 is a time chart showing pressure detection values of the pressure sensor 145 and opening-closing states of the first valve 143 and the second valve 146 in processes in FIG. 4. For example, when the control device of the fuel cell system 100 starts the processing flow shown in FIG. 4 during the operation of the fuel cell system 100, the control device of the fuel cell system 100, first, executes a third control in which both of the first valve 143 and the second valve 146 are closed (process P201).

Next, for example, the control device of the fuel cell system 100 executes a process P202 of measuring a third pressure decrease rate PDR3 when the above third control is executed, and a leakage determination process P203. In the leakage determination process P203, the control device of the fuel cell system 100 determines whether the third pressure decrease rate PDR3 satisfies a leakage condition, based on a comparison between the third pressure decrease rate PDR3 and a predetermined value PDRt of the pressure decrease rate.

For example, the predetermined value PDRt of the pressure decrease rate is a pressure decrease rate when the pressure detection value of the pressure sensor 145 decreases from a predetermined pressure P2 to a predetermined pressure P3 in a period from time t0 to time t1, as shown by a two-dot chain line in FIG. 5. For example, the predetermined value PDRt of the pressure decrease rate can be estimated based on the consumed amount of the anode gas due to the electricity generation of the fuel cell stack 110 and the consumed amount of the anode gas due to cross leakage.

For example, the consumed amount of the anode gas due to the electricity generation of the fuel cell stack 110 is estimated by calculating the anode gas amount that is consumed in the chemical reaction, based on the detection value of a current sensor that detects the generated electric current of the fuel cell stack 110. Further, for example, the consumed amount of the anode gas due to the cross leakage can be decided from the hardware characteristic of unit fuel cells that constitutes the fuel cell stack 110.

In the leakage determination process P203, for example, when the third pressure decrease rate PDR3 is not higher than the predetermined value PDRt of the pressure decrease rate, the control device of the fuel cell system 100 determines that the leakage condition is not satisfied (NO). Thereafter, the control device of the fuel cell system 100 ends the processing flow shown in FIG. 4.

On the other hand, for example, when the third pressure decrease rate PDR3 is higher than the predetermined value PDRt of the pressure decrease rate as shown in FIG. 5, the control device of the fuel cell system 100 determines that the leakage condition indicating the occurrence of the leakage from the anode gas circulation path 141 is satisfied (YES). Thereafter, the control device of the fuel cell system 100 executes processes P204 to P209, which are the same as the processes P102 to P107 in the above-described processing flow shown in FIG. 2.

Next, for example, the control device of the fuel cell system 100 executes at least one of a third determination process P210 and a fourth determination process P211. In the example shown in FIG. 5, the second pressure decrease rate PDR2 of the pressure detection value of the pressure sensor 145, which is the pressure decrease rate measured in a period from time t4 to time t5, is higher than the first pressure decrease rate PDR1 of the pressure detection value of the pressure sensor 145, which is the pressure decrease rate measured in a period from time t2 to time t3.

In this case, in the third determination process P210, for example, the control device of the fuel cell system 100 determines that the second pressure decrease rate PDR2 is higher than the first pressure decrease rate PDR1 (YES), and executes a process P212 of determining that the first valve 143 as the gas emission valve has a first-valve opening abnormality that hinders the closing operation of the first valve 143. That is, when the second pressure decrease rate PDR2 is higher than the first pressure decrease rate PDR1, there is a possibility that the first valve 143 that needs to be closed is not sufficiently closed and the anode gas leaks from the first valve 143. Thereafter, the control device of the fuel cell system 100 ends the processing flow shown in FIG. 4.

On the other hand, for example, when the control device of the fuel cell system 100 determines that the second pressure decrease rate PDR2 is not higher than the first pressure decrease rate PDR1 in the above-described third determination process P210 (NO), the control device of the fuel cell system 100 executes the fourth determination process P211. For example, when the control device of the fuel cell system 100 determines that the first pressure decrease rate PDR1 is not higher than the second pressure decrease rate PDR2 in the fourth determination process P211 (NO), the control device of the fuel cell system 100 ends the processing flow shown in FIG. 4.

On the other hand, for example, when the control device of the fuel cell system 100 determines that the first pressure decrease rate PDR1 is higher than the second pressure decrease rate PDR2 in the above-described fourth determination process P211 (YES), the control device of the fuel cell system 100 executes a process P213 of determining that the second valve 146 as the gas-liquid emission valve has a second-valve opening abnormality that hinders the closing operation of the second valve 146. That is, when the first pressure decrease rate PDR1 is higher than the second pressure decrease rate PDR2, there is a possibility that the second valve 146 that needs to be closed is not sufficiently closed and the anode gas leaks from the second valve 146. Thereafter, the control device of the fuel cell system 100 ends the processing flow shown in FIG. 4.

The detection values of the pressure sensor 145 after the anode gas replacement processes P204 and P207 are equalized for uniforming the condition in the process P206 of measuring the first pressure decrease rate PDR1 and the process P209 of measuring the second pressure decrease rate PDR2. Further, for restraining the influence of the consumption of the anode gas due to the electricity generation of the fuel cell stack 110, the processes P204 to P209 are executed when the fuel cell stack 110 generates an identical electric current. Further, the anode gas amount that is consumed due to the electricity generation of the fuel cell stack 110 in the processes P204 to P209 may be calculated, and the first pressure decrease rate PDR1 and the second pressure decrease rate PDR2 may be corrected in the processes P206 and P209.

As described above, the fuel cell system 100 in the embodiment includes the pressure sensor 145, the first valve 143 as the gas emission valve, the second valve 146 as the gas-liquid emission valve, and the control device that determines the opening-closing abnormality of the first valve 143 and the second valve 146. The pressure sensor 145 is provided on the anode gas circulation path 141 through which the anode off-gas emitted from the fuel cell stack 110 is circulated to the fuel cell stack 110. The first valve 143 opens and closes the gas emission path 152 that branches from the anode gas circulation path 141. The second valve 146 is coupled to the gas-liquid separator 142 provided on the anode gas circulation path 141, and at the time of the opening of the second valve 146, the gas and liquid are emitted from the gas-liquid separator 142 to the gas-liquid emission path 151. The control device of the fuel cell system 100 in the embodiment determines the opening-closing abnormality of the first valve 143 or the second valve 146, based on a comparison between the first pressure decrease rate PDR1 and the second pressure decrease rate PDR2. The first pressure decrease rate PDR1 is the decrease rate of the pressure detection value of the pressure sensor 145 when the first control in which the first valve 143 as the gas emission valve is opened in the state where the second valve 146 as the gas-liquid emission valve is closed is executed. The second pressure decrease rate PDR2 is the decrease rate of the pressure detection value of the pressure sensor 145 when the second control in which the second valve 146 as the gas-liquid emission valve is opened in the state where the first valve 143 as the gas emission valve is closed is executed.

By this configuration, in the fuel cell system 100 in the embodiment, the control device can determine the opening-closing abnormality of the first valve 143 and the second valve 146, based on a comparison between the first pressure decrease rate PDR1 when only the first valve 143 of the first valve 143 and the second valve 146 is opened and the second pressure decrease rate PDR2 when only the second valve 146 is opened.

Further, as shown in FIG. 2, when the first pressure decrease rate PDR1 is lower than the second pressure decrease rate PDR2, the control device of the fuel cell system 100 in the embodiment determines that the first valve 143 has the first-valve closing abnormality that hinders the opening operation of the first valve 143. Further, as shown in FIG. 2, when the second pressure decrease rate PDR2 is lower than the first pressure decrease rate PDR1, the control device of the fuel cell system 100 in the embodiment determines that the second valve 146 has the second-valve closing abnormality that hinders the opening operation of the second valve 146.

By this configuration, for example, when the vehicle cannot start below zero, it is possible to discriminate the first-valve closing abnormality and the second-valve closing abnormality that hinder the respective opening operations of the first valve 143 and the second valve 146 due to the breakdown or freezing of components. Thereby, it is possible to resolve the closing abnormality of the first valve 143 as the gas emission valve that is used for the anode gas replacement at the start of the vehicle below zero, to cause the anode gas replacement to be performed at the start below zero, and to prevent the degradation of the fuel cell stack 110.

Further, for example, at the time of the system end process, the control device of the fuel cell system 100 in the embodiment measures the first pressure decrease rate PDR1 and the second pressure decrease rate PDR2. In this case, the anode gas is not consumed by the electricity generation of the fuel cell stack 110, and the decrease rate of the pressure detection value of the pressure sensor 145 can be measured with high accuracy. Further, the processes P104 and P107 of measuring the first pressure decrease rate PDR1 and the second pressure decrease rate PDR2 are executed together with the anode gas replacement processes P102 and P105, which are usually executed, and thereby the anode gas can be restrained from being needlessly consumed.

Furthermore, for example, the control device of the fuel cell system 100 in the embodiment determines whether the leakage condition is satisfied, that is, whether the third pressure decrease rate PDR3 that is the decrease rate of the pressure detection value of the pressure sensor 145 when the third control in which both of the first valve 143 and the second valve 146 are closed is executed is higher than the predetermined value PDRt. Further, when the above leakage condition is satisfied and the second pressure decrease rate PDR2 is higher than the first pressure decrease rate PDR1, the control device of the fuel cell system 100 in the embodiment determines that the first valve 143 as the gas emission valve has the first-valve opening abnormality that hinders the closing operation of the first valve 143. Further, when the above leakage condition is satisfied and the first pressure decrease rate PDR1 is higher than the second pressure decrease rate PDR2, the control device of the fuel cell system 100 in the embodiment determines that the second valve 146 as the gas-liquid emission valve has the second-valve opening abnormality that hinders the closing operation of the second valve 146.

By this configuration, for example, in the fuel cell system 100 in the embodiment, when the anode gas circulation path 141 satisfies the leakage condition, the control device can determine that the first valve 143 or the second valve 146 has the opening abnormality.

As described above, with the embodiment, it is possible to provide the fuel cell system 100 that can determine the opening-closing abnormality of the first valve 143 as the gas emission valve and the second valve 146 as the gas-liquid emission valve.

The embodiment of the fuel cell system according to the present disclosure has been described above in detail with use of the drawings. Specific configurations are not limited to the embodiment, and even when design alterations and the like are performed without departing from the spirit of the present disclosure, the design alterations and the like are also included in the present disclosure.

What is claimed is:

1. A fuel cell system comprising:
a pressure sensor provided on an anode gas circulation path through which anode off-gas emitted from a fuel cell stack is circulated to the fuel cell stack;
a first valve configured to open and close a gas emission path that branches from the anode gas circulation path;
a second valve coupled to a gas-liquid separator provided on the anode gas circulation path, gas and liquid being emitted from the gas-liquid separator to a gas-liquid emission path at a time of opening of the second valve; and
a control device configured to determine opening-closing abnormality of the first valve and the second valve, wherein
the control device determines the opening-closing abnormality of the first valve or the second valve based on a comparison between a first pressure decrease rate and a second pressure decrease rate, the first pressure decrease rate being a decrease rate of a pressure detection value of the pressure sensor when a first control is executed, the first control being a control in which the first valve is opened in a state where the second valve is closed, the second pressure decrease rate being a decrease rate of the pressure detection value of the pressure sensor when a second control is executed, the second control being a control in which the second valve is opened in a state where the first valve is closed.

2. The fuel cell system according to claim 1, wherein:
when the first pressure decrease rate is lower than the second pressure decrease rate, the control device determines that the first valve has a first-valve closing abnormality that hinders opening operation of the first valve; and
when the second pressure decrease rate is lower than the first pressure decrease rate, the control device determines that the second valve has a second-valve closing abnormality that hinders opening operation of the second valve.

3. The fuel cell system according to claim 1, wherein:
the control device determines whether a leakage condition is satisfied, the leakage condition being a condition that a third pressure decrease rate is higher than a predetermined value, the third pressure decrease rate being a decrease rate of the pressure detection value of the pressure sensor when a third control is executed, the third control being a control in which both of the first valve and the second valve are closed;
when the leakage condition is satisfied and the second pressure decrease rate is higher than the first pressure decrease rate, the control device determines that the first valve has a first-valve opening abnormality that hinders closing operation of the first valve; and
when the leakage condition is satisfied and the first pressure decrease rate is higher than the second pressure decrease rate, the control device determines that the second valve has a second-valve opening abnormality that hinders closing operation of the second valve.
